(19) United States
(12) Patent Application Publication
(10) Pub. No.: US 2004/0070704 A1
(43) Pub. Date: Apr. 15, 2004

(54) Multilayer plate for the fabrication of a display panel

(76) Inventors: Pavel I. Lazarev, Belmont, CA (US); Michael V. Paukshto, San Mateo, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/250,633

(22) PCT Filed: Oct. 1, 2002
(86) PCT No.: PCT/US02/31512

(30) Foreign Application Priority Data
Oct. 2, 2001 (RU) 2001126491

(51) Int. Cl. G02F 1/1335

(52) U.S. Cl. 349/96

(57) ABSTRACT

The invention pertains to displays and devices, and discloses designs of a multilayer plate, which may be used in the manufacture of displays, and a design of a display with internal polarizers.

The technical result of the disclosed invention is the increase of reliability and decrease of thickness of the display, as well as lowering of the manufacturing costs, an increase of useful yield and lowering the number of manufacturing operations in the process of display assembly.

The disclosed designs comprise an optically transparent substrate, a protective layer, a conducting layer, and at least one layer of an anisotropic thin crystal film. The thin crystal film is formed out of a material, which contains aromatic rings and has Bragg peak at 3.4±0.2 A along one of optical axes.

### RELATED APPLICATIONS

This application claims priority to Russian Application Serial No. 2001126491 filed Oct. 2, 2001.

The herein invention pertains to devices for displaying information, in particular to elements of liquid crystal (LC) displays.

Traditionally, liquid crystal displays are implemented in the form of a flat cuvette, formed having two parallel plates, on the inner surfaces of which there has been provided a system of electrodes made of optically transparent conducting material (for example, solid solution SnO₂ and I₂O₃—ITO). The surfaces of plates with electrodes are usually coated with a layer of polyimide or other polymer and then subjected to a special processing, which provides the particular uniform orientation of molecules of the liquid crystal (LC) near the surfaces of the plates as well as in the bulk of liquid crystal layer in the display. After assembling the cuvette it is filled with liquid crystal, which forms a layer with thickness of 5-20 μm. LC represents the active medium, changing its optical properties under the influence of electric field. The change in optical properties is registered in crossed polarizers, which are usually adhered on the outer sides of the cuvette [L. K. Vistin. JVHO, 1983, vol. XXVII, ed.2, pp.141-148].

In the prior art, display panels are fabricated out of plates having glass substrate and a conducting layer. The glass plates should be very flat and be free from bubbles and other optical defects. Depending on the operating conditions of the display one uses the blank with various conducting layers. For displays operating in transmission, the conducting layers are transparent. For displays operating in reflection mode, the front plate of the display is made with transparent conducting layer, and the rear one—with reflecting conducting layer. [A. A. Groshev, V. B. Sergeev, Devices for presenting information based on LC, <<Energia>>, L. 1977]. Transparent conducting layers have surface resistance from 10 to 10² Ohm, and transmission coefficient of 0.7-0.9 in the visible region of the spectrum. Conducting layers are formed via well-known deposition methods.

Usually, a matrix of display panels is formed on each of the plates. The necessary configuration of electrodes on each display panel is created via mask etching. Electrodes come out to the edge of the glass, where they terminate with the contact pad for attaching external leads. Separate panels are divided by etched grooves, along which the displays are later glued together. To create the necessary gap between the panels, they are separated by spacers along their perimeter. Assembled display panel (or a matrix of panels) is filled with LC material in vacuum, while the plates are heated. This provides lower viscosity of LC and better filling of the gap between the panels of the display. Displays in the matrix are then separated from each other (scribed and broken) and each cuvette is then sealed. Polarizers protected by the protective layer and/or covered by a glass plate are adhered on the outside of the cuvette.

To prevent diffusion of ions from the glass into the layer of liquid crystal during display operation, the conducting layer is usually separated from the glass by a protective layer. Usually this protective layer is a film of silicon oxide or oxides of heavy metals, although some polymers may also be used. The Protective layer should be transparent in the working region of the spectrum, and its thickness and density should provide dependable isolation of glass from LC.

There are large variety of methods to obtain protective coatings: physical methods based on evaporation or sputtering of materials, or chemical methods based on utilization of chemical reactions [N. P. Gvozdeva et al., Physical optics, M. <<(Meshinostroenie)>>, 1991, pp. 178-179]. At the present time, the most prevalent method is evaporation in vacuum. The essence of this method is in thermal evaporation of the material in deep vacuum. Created vapor condenses on the surface of the substrate in the form of thin film. This process happens quickly—from several seconds to a few minutes.

The other physical method is cathode sputtering. The process is based on knocking out atoms of a cathode material by bombarding it with ions of rarefied gas with high energy. Atoms knocked out of the surface of the cathode settle down on the substrate. During reaction cathode sputtering, the working chamber is filled with active gas (for example, oxygen), which allows obtaining films with necessary chemical composition.

One of the chemical methods, for example, is the method of forming films from solutions of hydrolyzing compounds. Then the oxide film is formed by application of silicon-ethyl solution onto the blank rotating in a centrifuge.

U.S. Pat. No. 5,358,739, 1994 describes the method of silicon oxide coatings via application of sylazane polymer onto the substrate and heating it in oxidizing medium. There are other methods as well.

Described in literature [WO 94/28073], there is polarizer, obtainable from liquid crystal solutions of organic dyes. A polarizer according to this technology is fabricated via depositing thin film of LC solution of the dye onto glass of polymer substrate with one of the known methods. The peculiarity of this technology is in the fact that orientation of molecules of the dye happens during deposition of the film, so that a thin thermally stable polarizing coating appears on the substrate directly after its drying. Application of these polarizers allows creating new configurations of liquid crystal displays, where polarizers may be formed directly on the walls of LC cuvette, on its inner as well as external sides. Internal positioning of polarizers appears more favorable, since it allows enhancing durability and dependability of the display, as well as simplifying its design and decreasing the number of fabrication operations.

With corresponding choice of deposition conditions and the degree of orienting influence, one may obtain dichroic polarizer comprising anisotropic film, at least a part of which has crystalline structure [PCT RU99/00400]. Such dichroic polarizers possess higher degree of anisotropy and thermal stability.

In the conventional display with internal polarizers, the dichroic polarizer is usually formed above the system of electrodes [RU2139559]. For this purpose, electrodes are coated with special planarizing layer, which also promotes good adhesion of the dichroic polarizer. This leads to an increase in the number of layers in the display (its thickness) and the number of manufacturing operations. Besides that, in this case dichroic polarizer may be deposited only after creation of the electrode system, which lowers flexibility of manufacturing process in order to change assortment of products.

The herein invention is aimed at creating a multilayer plate, which can be used in display manufacturing, as well as designing of displays with internal polarizers.

The technical result of the disclosed invention is the increase of durability and decrease of thickness of displays, as well as lowering the cost of their manufacturing, increase of useful yield and decrease of the number of manufacturing operations.

Technical result is achieved by the fact that multilayer plate comprises optically transparent substrate, protective layer, conductive layer and at least one layer of anisotropic membranous crystal. The membranous crystal is created by a material, which contains aromatic rings and has Bragg peak at 3.4±0.2 A along one of the optical axes. At least one layer of the membranous crystal is situated between the substrate and the conducting layer and separated from the latter by the protective layer. Material of the membranous crystal may contain heterocycles.

The substrate of the multilayer plate may be made of glass, while the protective layer may be made out of silicon oxide and/or oxide(s) of heavy metal(s) or polymer(s). The conducting layer is usually made out of ITO.

Sometimes the layer of ITO may be deposited onto a metal grid (for example, via mask sputtering) in order to increase conductivity of the layer. Then total surface area of the metal grid should be less than 10% of the total area of the multilayer plate.

Usually, membranous crystal represents an E-type polarizer. Sometimes, membranous crystal may simultaneously function as the polarizer and as phase-shifting layer.

Sometimes, at least a part of the protective layer may be made conductive by, for example, doping its surface.

In order to prevent damaging during transportation, it is preferred to a additionally coat the multilayer plate with polymer film(s).

The said technical result is achieved due to the fact that the display panel comprises optically transparent substrate, protective layer, a system of electrodes and at least one layer of membranous crystal. The membranous crystal is formed by the material comprising aromatic rings and has Bragg peak at 3.4±0.2 A along one of the optical axes. At the same time, at least one layer of membranous crystal is situated between the substrate and the system of electrodes and is separated from the latter by the protective layer.

Material of the membranous crystal may contain heterocycles.

The substrate of the display panel may be implemented out of glass. Protective layer may be implemented out of silicon oxide and/or oxide(s) of heavy metal(s) or polymer(s). The system of electrodes is usually made of ITO.

A metal grid may be deposited onto the layer of ITO in the panel of the display. Then total surface area of the grid should be less than 10% of the total area of electrodes.

Membranous crystal in the display usually represents an E-type polarizer.

Sometimes membranous crystal in the display may combine functions of polarizer and of phase-shifting layers.

Display panel may additionally comprise adhesion layer(s).

The multilayer plate according to the disclosed invention comprises the following main layers: optically transparent substrate (usually soda-lime glass), optically anisotropic layer membranous crystal formed by material containing aromatic cycles and having Bragg peak at 3.4±0.2 A along one of the optical axes, protective layer, for example silicon oxide, and conducting layer, usually ITO.

Optically anisotropic layer performs as the polarizer in the display, or simultaneously as the polarizer and as phase-shifting layer. It is necessary that this layer is at least partially crystalline; this will provide high durability of its structure and the required optical parameters. The initial choice of material for this layer is determined by the presence of developed system of π-conjugate bonds in the aromatic cycles and the presence of groups like amine, phenol, ketone and other, lying in the planes of molecules and being a part of the aromatic bond system of these molecules. Molecules themselves, or their fragments have flat construction. For example, this could be such organic materials as indanthrone (Vat Blue 4), or dibenzoimidazolel,4,5,8-naphthalentetracarboxylic acid (Vat Red 14), or dibenzoimidazole 3,4,9,10-perylenetetracarboxylic acid, or quinacridone (Pigment Violet 19) or other, derivatives of which or their mixtures form stable lyotropic liquid crystal phase.

When such organic material is dissolved in suitable solvent, resulting is the colloid system (lyotropic liquid crystal) where molecules aggregate into supramolecular complexes, which represent kinetic units of the system. LC is the pre-ordered state of the system, from which, in the process of alignment of the supramolecular complexes and subsequent removal of the solvent, appears anisotropic crystalline film (or in other words—membranous crystal).

The method of obtaining membranous crystals from colloid system with supramolecular complexes comprises:

deposition of that colloid system onto the substrate; the colloid system should also be thixotropic, for which purpose the colloid system should be at certain temperature and have certain concentration of the dispersion phase;

bringing the deposited or depositing colloid system into the state of increased fluidity via any kind of external influence, providing decrease of viscosity of the system (this may be heating, shear deformation, etc.); external influence may continue during the whole subsequent process of alignment or take the time necessary in order so that the system could not relax into the state with heightened viscosity during the time of alignment;

external aligning influence on the system, which may be performed by mechanical as well as any other method; the degree of the said aligning influence should be sufficient for kinetic units of the colloid system to obtain the necessary orientation and form the structure, which will be the foundation of the future crystalline lattice of the forming layer;

conversion of the aligned region of the forming layer from the state with heightened viscosity, which was achieved due to the initial external influence, into the state with the original or even higher viscosity of the system; this is performed in such a way as to avoid disorientation of the structure of the forming layer and to prevent formation of defects on the surface of the layer;

the next operation is drying (solvent removal), in the process of which the crystalline structure is formed;

the concluding operation is usually the conversion of membranous crystal into water-insoluble form, via processing its surface with solution containing ion of 2- and 3-valence metals.

The planes of molecules in the obtained layer are parallel to each other and the molecules form three-dimensional crystal, in at least a part of the layer. When this fabrication method is optimized, it is possible to obtain mono-crystalline layers. Optical axis in such membranous crystal will be perpendicular to the planes of molecules. Such membranous crystal will possess high degree of anisotropy and high refraction index for at least one direction.

To obtain a layer with the desired optical characteristics it is possible to mix colloid systems (in which case combined supramolecular complexes will form). In layers obtained from mixtures of colloid solutions, absorption and refraction may assume various value within limits determined by the original components. Mixing of various colloid system and resulting creation of combined supramolecular complexes is possible due to coincidence of one of dimensions of molecules of the above-listed organic compounds (3.4). Molecules in the wet layer have long dimensions in at least one direction, which is due to alignment of supramolecular complexes on the substrate. When the solvent is evaporated, it appears more energetically favorable for the molecules to form three-dimensional crystalline structure.

Control over the thickness of the layer is performed through the content of solid matter in the depositing solution and thickness of the wet layer on the substrate. Manufacturing parameter in fabricating such films is the concentration of the solution, which is conveniently controlled during fabrication. The degree of crystallinity of the layer may be controlled using rontgenogram or optical methods.

The distinctive feature of the membranous crystal is the high thermal stability, which is especially important in the contemporary technology of display fabrication.

The layer of silicon oxide is necessary to protect the anisotropic layer from destructive external impacts during fabrication process, in particular during etching of ITO, and insulating it from the contact with electrodes and LC during operation of the display. The layer of silicon oxide is formed using the known methods: evaporation in vacuum while heating, cathode sputtering, the so-called “wet method”—from solutions and others. Protective layer, aside from the silicon oxide, may also contain oxides of heavy metals. For example composition of CERAMATE, used for creating protective layer from solution, contains up to 6% wt. of solid phase (TiO₂, ZrO₂, SiO₂, Sb₂O₅). The layer obtainable from solution is usually baked at high temperature. Performing this operation in the process of fabricating multilayer plates is possible due to high thermal stability of the anisotropic layer. It can withstand heating up to 180° C. or brief heating up to 250° C. and higher without significant modification of optical characteristics.

In the capacity of protective layer one may also use various thermally stable and chemically resistant polymers. Thermal stability of all layers in the multilayer plate is necessary, since a number of manufacturing operations (for example, creating planarizing and aligning layer of polyimide on top of the system of electrodes) include heating to a high temperature.

Conducting layer (ITO) is formed via one of the known methods.

Moreover, the multilayer plate may contain additional external layers, which protect it during transportation, and which can be removed during fabrication of displays.

Such multilayer plate represents the blank for fabricating display panels and already contains main functional layers of the display. This allows simplifying technology of fabricating liquid crystal displays by cutting down the number of manufacturing operations.

Dimensions of the multilayer plate are determined by the requirements set forth by the manufacturers of displays. Usually, each plate accommodates several display panels. Area of each display panel on the plate is equipped with corresponding electrode system and grooves, along which the displays are later glued together. Removal of material of the conducting layer on the corresponding areas of the plate may be performed via photolithography, laser ablation, etc.

Density and thickness of the protective layer should be sufficient, in order to prevent destruction of the anisotropic membranous crystal during photolithography and other analogous methods of etching of the conducting layer.

When applying laser ablation to create the grooves for gluing the LC cuvette, at the time when the conducting layer is removed, the silicon oxide protective layer may be fused together with the glass.

After that, the system of electrodes is usually coated with polyimide layer, which functions as the planarizing and LC aligning layer. Other materials could be used in the capacity of the planarizing layer, in particular, silicon oxide. In this case material of this layer will additionally function as the insulator, preventing discharge between electrodes.

After creating the matrixes of the front and the rear panels of displays, corresponding plates are bonded, and the formed cuvettes are filled with liquid crystal. When this is complete, individual LC displays are separated from the matrix. Created liquid crystal displays have internal polarizers. This allows to simplify design of displays, decrease their thickness and increase their durability in operation.

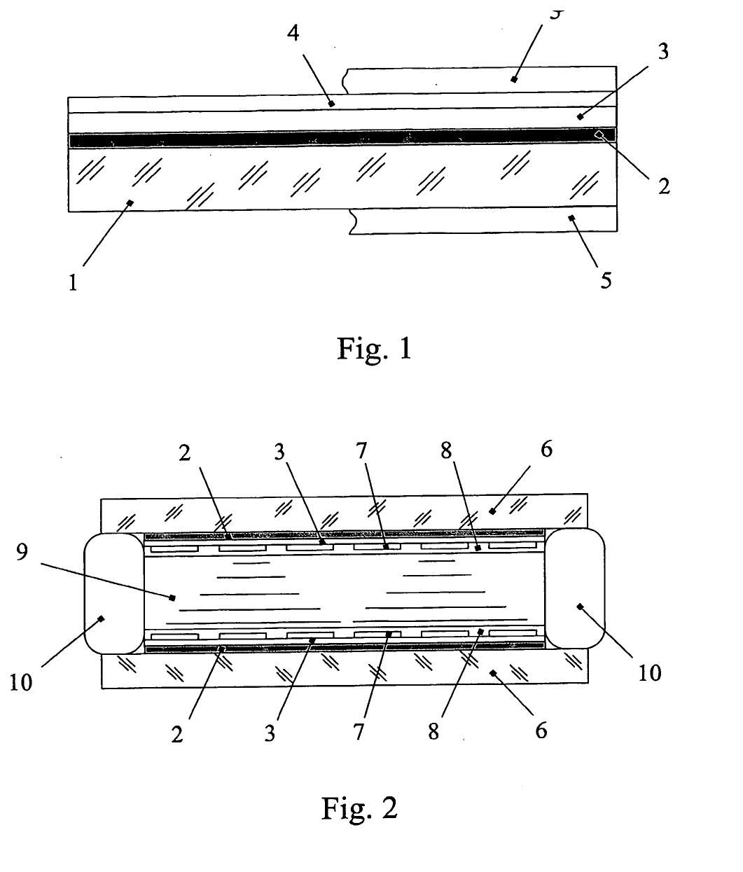

The essence of the invention is illustrated by the following schematics: FIG. 1 presents diagram of the multilayer plate according to the disclosed invention, FIG. 2 presents diagram of the liquid crystal display with internal polarizers.

Multilayer plate in one of examples of embodiment (FIG. 1) comprises optically transparent substrate 1 made out of soda-lime glass and polarizer 2, which represents membranous crystal made from 9.5% aqueous solution of sulfonated indanthrone. The thickness of the polarizer is about 100 nm. Silicon oxide protective layer 3 is deposited over the polarizer, and then conducting layer 4, usually ITO is deposited on top of that. During transportation the plate is usually protected by polymer films 5.

Such multilayer plate represents the blank for manufacturing display panels and already bears the main functional layers of the display. One of the possible designs of the display with internal polarizes is presented in the FIG. 2. The display represents a flat cuvette, created by two parallel glass plates 6, on the inner surface of which the following layer have been sequentially formed: layer of polarizer 2, protective layer 3 of silicon oxide, system of electrodes 7 made from optically transparent conducting material (ITO) and layer 8 of polyamide, which is the aligning layer. After assembling the cuvette it is filled with liquid crystal and sealed, with, for example, sealant 10.

The design of the display with internal polarizers allows decreasing the thickness of the device and enhancing its reliability in operation. Besides that, optical properties of membranous crystals utilized in such displays as anisotropic layers, allow creating devices with contrast and wide observation angle.

1. A multilayer plate comprising:
an optically transparent substrate,
a protective layer,
a conducting layer, and
at least one layer of an anisotropic thin crystal film, material of which contains aromatic rings and has Bragg peak at 3.4±0.2 A along at least one of the optical axes,
wherein at least one layer of thin crystal film is situated between the substrate and the conducting layer and is separated from the latter by the protective layer.

2. The multilayer plate according to claim 1, wherein material of the thin crystal film contains heterocycles.

3. The multilayer plate according to claims 1 or 2, wherein the substrate is made of glass.

4. The multilayer plate according to claim 1, wherein the protective layer is made of one or more materials selected from the group consisting of silicon oxide, oxide of heavy metal and polymer.

5. The multilayer plate according to claim 1, wherein the conducting layer is made of ITO.

6. The multilayer plate according to claim 5, wherein a metal grid is deposited over the ITO layer.

7. The multilayer plate according to claim 6, wherein the total surface area of the metal grid is less than 10% of the total surface area of the multilayer plate.

8. The multilayer plate according to claim 1, wherein the thin crystal film represents an E-type polarizer.

9. The multilayer plate according to claim 1 or 2, wherein the thin crystal film represents simultaneously a polarizer and phase-shifting layers.

10. The multilayer plate according to claim 1, wherein at least a part of the protective layer is conducting.

11. The multilayer plate according to claim 1, wherein the multilayer plate is further coated with at least one layer of a polymer film.

12. A display panel comprising:
an optically transparent substrate,
a protective layer,
a system of electrodes, and
at least one layer of thin crystal film, material of which contains aromatic rings and has Bragg peak at 3.4±0.2 A along one of the optical axes,
wherein at least one layer of the thin crystal film is situated between the substrate and the system of electrodes and is separated from the latter by the protective layer.

13. The display panel according to claim 12, wherein the material of the thin crystal film contains heterocycles.

14. The display panel according to claims 12 or 13, wherein the substrate is made of glass.

15. The display panel according to claim 12, wherein the protective layer is made of one or more materials selected from the group consisting of silicon oxide, oxide of heavy metal, polymer silicon oxide, and oxide of heavy metal or polymer.

16. The display panel according to claim 12, wherein the conducting layer is made of ITO.

17. The display panel according to claim 16, wherein a metal grid is deposited over the ITO layer.

18. The display panel according to claim 17, wherein the total surface area of the metal grid is less than 10% of the total surface area of the electrodes.

19. The display panel according to claim 12 or 13, wherein the thin crystal film represents an E-type polarizer.

20. The display panel according to claim 12 or 13, wherein the thin crystal film represents simultaneously a polarizer and phase-shifting layers.

21. The display panel according to claim 12, wherein the display panel further comprises at least one adhesion layer.
